(19) United States
(12) Patent Application Publication
(10) Pub. No.: US 2016/0195862 A1
(43) Pub. Date: Jul. 7, 2016

(54) MANAGING A SENSORY FACTOR

(71) Applicant: HEWLETT PACKARD ENTERPRISE DEVELOPMENT LP, Houston, TX (US)

(72) Inventors: Adi Kidron, Yehud (IL); Erez Yaary, Yehud (IL); Yael Keren, Yehud (IL); Jecky Toledo, Yehud (IL)

(73) Assignee: HEWLETT PACKARD ENTERPRISE DEVELOPMENT LP, Houston, TX (US)

(21) Appl. No.: 14/916,577

(22) PCT Filed: Sep. 6, 2013
(86) PCT No.: PCT/US13/58415

§ 371 Date: Mar. 4, 2016

(51) Int. Cl. G05B 15/02

(52) U.S. Cl. CPC G05B 15/02

(57) ABSTRACT

Managing a sensory factor for an environment includes identifying a plurality of individuals expected to be present in an environment at a future time. Preference data for the plurality of individuals is accessed. The preference data for each individual includes a preferred setting value. The preference data for the identified plurality of individuals is processed to identify a setting for the sensory factor. The setting satisfies a rule applied to the preference data. The rule includes averaging such that the setting represents, at least in part, an average of the preferred setting values of the plurality of individuals. The setting is applied to modify the sensory factor from a current state to a desired state before the individuals are schedule to be present.

### BACKGROUND

Within a given environment, many sensory factors may be adjusted to an individual's preference. Examples include temperature, volume level, music genre or playlist, lighting levels and even colors and fonts of a presentation. Difficulties can arise when different individuals have different preferences for the same sensory factor.

### DRAWINGS

FIG. 1 is a block diagram depicting an example setting in which various embodiments may be implemented.

FIG. 2 is a block diagram depicting an example of a system for managing a sensory factor.

FIG. 3 is a block diagram depicting an example data structure for presence and preference data.

FIG. 4 is a block diagram depicting a memory resource and a processing resource according to an example.

FIG. 5 is a flow diagram depicting steps taken to implement an example.

### DETAILED DESCRIPTION

INTRODUCTION: Within a given environment, many sensory factors may be adjusted to an individual's preference. A sensory factor as used herein is a condition within an environment that can be perceived by an individual using one or more of the individual's senses. Examples include temperature, volume level, music genre or playlist, lighting levels, aromas, and even colors and fonts of a presentation. Difficulties can arise when different individuals have different preferences for the same sensory factor. Imagine, for example, a conference room having its own heating and cooling zone. Different individuals attending a meeting in that room can have different temperature preferences. Further, in hot summer months, the cooling may be turned off when the room is not in use. It can take time for a group to reach a consensus on a desired temperature and additional time for the room to reach that desired temperature once a decision has been made.

Embodiments described below operate to identify those individuals expected to be in an environment at a point in the future. For example, this can be accomplished by accessing a calendar event or a reservation list. Preference data for the each individual in the group specifies the individual's preference with respect to a sensory factor such as temperature that can be adjusted. The preference data for the identified group can be processed against a rule to identify a setting to achieve a desired state for the sensory factor.

The rule may include averaging such that the identified setting represents, at least in part, an average of the group's preferences. Such an average may be an average temperature, volume lever, or lighting level. As applied to music, the average may be a particular genre or playlist representative of the group preference. The identified setting is then applied to modify the sensory factor from a current state to a desired state represented by the setting. Such may be accomplished in an automated fashion by sending an instruction to a digital thermostat, lighting control, or audio/visual control system.

The following description is broken into sections. The first, labeled “Components,” describes examples of various physical and logical components for implementing various embodiments. The second section, labeled “Operation,” describes steps taken to implement various embodiments.

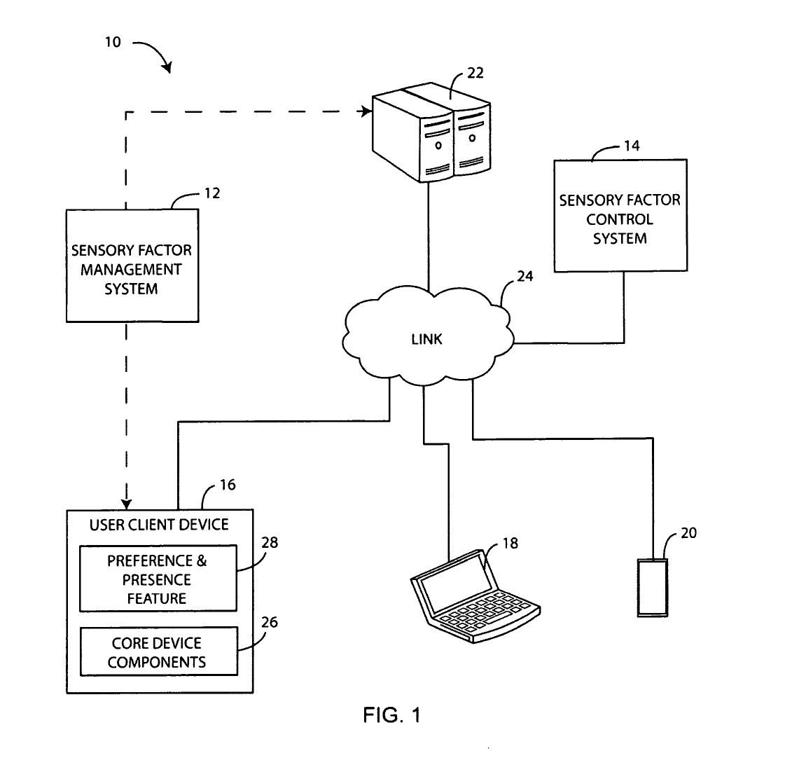

COMPONENTS: FIG. 1 depicts an example setting 10 in which embodiments may be implemented as sensory factor management system 12. Setting 10 is shown to include sensory factor control system 14, client devices 16, 18, and 20 and server device 22. Components 14-22 are interconnected via link 24. Link 24 represents generally any infrastructure or combination of infrastructures configured to enable electronic communication between components 14-22. For example, link 24 may represent the internet, one or more intranets, and any intermediate routers, switches, and other interfaces.

Sensory factor control system 14 represents any device or combination of devices configured to control a sensory factor such as temperature, lighting, and audio visual characteristics such as music genre or playlist, presentation color and font, and volume. Examples include remotely accessible thermostats, lighting systems, and video and audio controllers. Client devices 16-20 represent generally any computing device with which a user may interact to communicate with other client devices and server device 22 via link 24. Server device 22 represents generally any computing device configured to serve an application and corresponding data for consumption by client devices 14-18 and for communicating instruction to control system 14.

Client device 16 is shown to include core device components 26 and preference and presence feature 28. Core device components 26 represent generally the hardware and programming for providing the computing functions for which device 16 is designed. Such hardware can include a processor and memory, touch display and any other user input features. The programming can include an operating system and applications. Preference and presence feature 28 represents an application or applications through which a user can actively or passively communicate her current location, an expected future location and her preferences with respect to a sensory factor. For example feature 28 may include a calendaring application though which the user can schedule meetings and other events at specified locations. Feature 28 may also include a location reporting application such as a GPS, Wi-Fi, Bluetooth or NFC enabled application and supporting hardware.

Sensory factor management system 12, discussed in more detail below, represents generally a combination of hardware and programming configured to identify those individuals expected to be in an environment at a point in the future and process preference data for those individuals against a rule to identify a setting specifying a desired state for a sensory factor. System 12 is configured to apply or otherwise communicate a setting for control system 14 to apply to cause the sensory factor to achieve a desired state at or before the time the individuals are expected to be in the environment. System 12 may be integrated within one or all of client devices 16-20. System 12 may be integrated in server device 22. System 12 may be distributed across server device 22 and client devices 16-20.

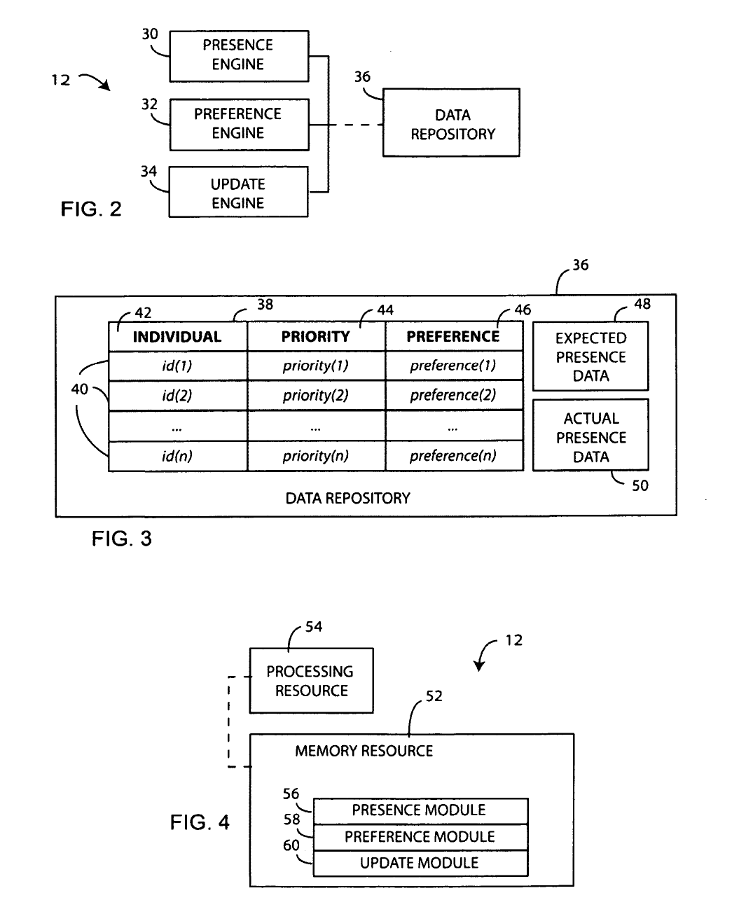

FIGS. 2-4 depict examples of physical and logical components for implementing various embodiments. In FIG. 2 various components are identified as engines 30-34. In describing engines 30-34, focus is on each engine's designated function. However, the term engine, as used herein, refers to a combination of hardware and programming configured to perform a designated function. As is illustrated later with respect to FIG. 4, the hardware of each engine, for example, may include one or both of a processor and a memory device, while the programing is code stored on that memory device and executable by the processor to perform the designated function.

FIG. 2 is a block diagram depicting components of sensory factor management system 12. In this example, system 12 includes presence engine 30, preference engine 32, and update engine 34. In performing their respective functions, engines 30-34 may access data repository 36. Repository 36 represents generally any memory accessible to system 12 that can be used to store and retrieve data.

Presence engine 30 is configured to process presence data to identify a plurality of individuals scheduled to be present in the environment at a future time. In other words, engine 30 is responsible for, at a first time, identifying individuals expected to be in a shared location at a second, later time. Such may be accomplished by accessing and processing calendar data that specifies a meeting between a group of individuals at a designated location. The same may be accomplished by accessing and processing reservation or event ticket data to identify the individuals.

Preference engine 32 is configured to process, before the individuals are scheduled to be present in the environment, preference data for the plurality of individuals to identify a setting for the sensory factor. The identified setting satisfies a rule applied to the preference data and corresponds to a desired state for the sensory factor. Update engine 34 is configured to apply the setting to modify the sensory factor from a current state to the desired state before the individuals are schedule to be present.

To summarize, system 12 operates to predict when a group of individuals is expected to be in a shared environment, use preference data for those individuals to identify a setting for a sensory factor, and apply that setting such that the sensory factor is in a desired state when the individuals are expected to arrive. As noted, preference engine 32 processes the preference data against a rule. The rule can take a number of forms. In one example, the rule may indicate averaging. The preference data for each identified individual may identify or otherwise correspond to a preferred setting value for a setting. The collected preferred setting values the group of individuals can then be, at least in part, averaged to identify the setting. Where the sensory factor is temperature, preference engine 32 may average the preferred temperatures of the individuals to identify a setting that is expected to achieve that average. The same may be achieved to identify a setting for an average brightness or volume. For music selection, the preferred setting values may represent preferred genres, songs, and the like. Processing the preference data for a group of individuals can be an averaging that identifies a shared genre or a collection of preferred songs or song types to include in a playlist.

In another example, preference data for each individual can, in addition to a preferred value, include a priority indicator. A priority indicator is data that can be used to weight a given individual's preferred setting value. For example, an individual identified as a VIP such as a meeting organizer, presenter, or manager may have a priority indicator that will weight their preferred setting value. Another priority indicator may be reflective of how important a sensory factor is to a given individual. For example, one may or may not care about room temperature. The rule used by preference engine 32 may include weighted averaging such that the identified setting represents an average of the preferred setting values weighted according to the corresponding priory indicators. Priority indicators may be indicative of status within a hierarchy. Here, the rule may prioritize the preferred setting values of the plurality of individuals according to the priority indicators such that the identified setting is influenced more by the preferred setting value of a one individual with a higher status than that of another.

A priority indicator may be indicative of a physical limitation affected by the sensory factor. For example, a color blind individual may desire to avoid certain colors in a projected presentation. A visually impaired person may desire a large font size. A hearing impaired individual may desire a louder than normal volume. Here, the rule used by preference engine 32 can give weight to the preferred setting values of a given individual having a priority indicator signifying a physical limitation affected by the sensory factor. The preference data is processed such that the identified setting substantially matches the preferred setting value of one of that given individual. For example, the colors or font size used in a presentation may be adjusted.

As described, system 12 operates to place a sensory factor at a desired state based on preferences of individuals expected to be in a given environment at a future time. Reality may prove different when not all of the individuals arrive or when additional individuals arrive. In other words, a fist group of individuals may be expected to be present at a scheduled time, but a second, different group may show up. Thus the setting selected by preference engine 32 may not correspond to a desired state of the sensory factor for the second group.

Here, presence engine 30 is configured to process presence data to identify individuals identified as being present within the environment at the scheduled time. Presence data here identifies those currently present at a corresponding location. For example, the presence data may be indicative of current locations actively or passively reported by a mobile devices carried by the individuals. Mobile devices may actively report GPS data. Location may be assessed by Wi-Fi signal strengths. Current location may also be determined based individuals logging into or otherwise reporting as present via a presentation service.

Preference engine 32 is configured to process preference data for that second group of individuals to identify an updated setting for the sensory factor that satisfies the rule applied to the preference data for the second group. The updated setting corresponds to an updated desired state for the sensory factor. Update engine 34 is then configured to apply the updated setting to modify the sensory factor from the previous desired state to the updated desired state.

FIG. 3 depicts an example implementation of data repository 36. Data repository, while shown as unified, may be distributed across any number of memory devices. In this example, repository 36 includes table 38 for maintaining preference data for any number of individuals. In this example, table 38 includes a number of entries 40 each populated with data in individual field 42, priority field 44, and preference field 46. Data in individual field 42 identifies a particular individual. Data in priority field 44 identifies a priority indicator associated with that individual. Data in preference field 46 identifies a preferred setting value for that individual. Together or separately, data in fields 44 and 46 of a given entry represent preference data for a specified individual. The priority indicator and preferred setting value identified in a given entry 40 correspond to a particular sensory factor. Thus, table 38 may include multiple entries 40 for a single individual with each of those entries corresponding to a different sensory factor. Or, each entry 40 may include priority indicators and preferred setting values for multiple sensory factors.

Data repository 36 is also shown to include expected presence data 48 and actual presence data 50. Expected presence data 48 represents data indicating which individuals are expected to be at a given location at a future time. As mentioned, such data can include calendar, reservation, or event ticketing data. Actual presence data 50 represents data indicating the current locations of the individuals. Thus, referring to FIG. 2, presence engine 30 may access and process expected and actual presence data to identify individuals expected to be present and later to identify individuals actually present in a given location. Using a list of individuals identified by presence engine 30, preference engine 32 can access and process preference data for those individuals using table 38.

In foregoing discussion, engines 30-34 were described as combinations of hardware and programming. Engines 30-34 may be implemented in a number of fashions. Looking at FIG. 4, the programming may be processor executable instructions stored on tangible memory resource 52 and the hardware may include processing resource 54 for executing those instructions. Thus memory resource 52 can be said to store program instructions that when executed by processing resource 54 implements system 12 of FIG. 2.

Memory resource 52 represents generally any number of memory components capable of storing instructions that can be executed by processing resource 54. Memory resource 52 is non-transitory in the sense that it does not encompass a transitory signal but instead is made up of more or more memory components configured to store the relevant instructions. Memory resource 52 may be implemented in a single device or distributed across devices. Likewise, processing resource 54 represents any number of processors capable of executing instructions stored by memory resource 54. Processing resource 54 may be integrated in a single device or distributed across devices. Further, memory resource 52 may be fully or partially integrated in the same device as processing resource 54, or it may be separate but accessible to that device and processing resource 54.

In one example, the program instructions can be part of an installation package that when installed can be executed by processing resource 54 to implement system 12. In this case, memory resource 52 may be a portable medium such as a CD, DVD, or flash drive or a memory maintained by a server from which the installation package can be downloaded and installed. In another example, the program instructions may be part of an application or applications already installed. Here, memory resource 52 can include integrated memory such as a hard drive, solid state drive, or the like.

In FIG. 4, the executable program instructions stored in memory resource 52 are depicted as presence module 56, preference module 46, and update module 60. Presence module 56 represents program instructions that when executed cause processing resource 54 to implement presence engine 30 of FIG. 2. Preference module 58 represents program instructions that when executed cause the implementation of preference engine 32. Likewise, update module 60 represents program instructions that when executed cause the implementation of update engine 34.

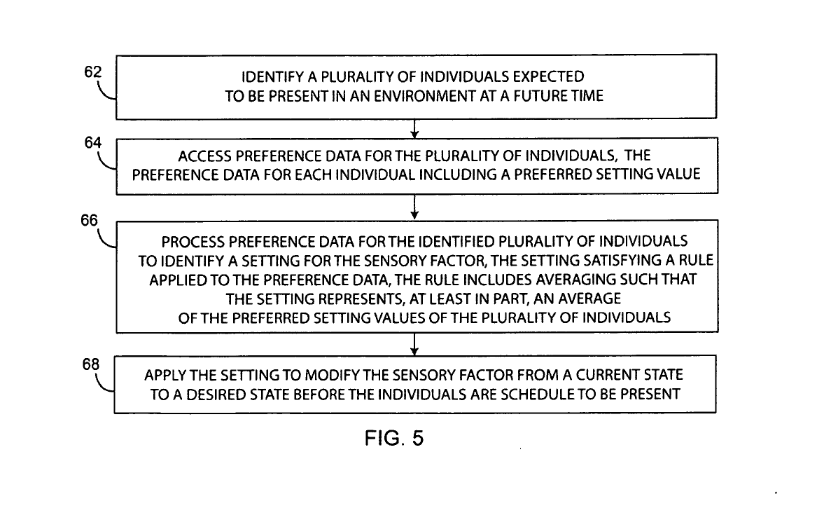

OPERATION: FIG. 5 is a flow diagram of steps taken to implement a method for managing a sensory factor. In discussing FIG. 5, reference may be made to components depicted in FIGS. 1-4. Such reference is made to provide contextual examples and not to limit the manner in which the method depicted by FIG. 5 may be implemented.

A plurality of individuals expected to be present in an environment at a future time are identified (step 62). Referring to FIGS. 2 and 3, presence engine 30 may be implement step 62 by accessing expected presence data 48 to identify a group of individuals expected to be in that environment. Preference data for the plurality of individuals is accessed (step 64). The preference data for each individual includes a preferred setting value. The preference data accessed in step 64 is processed to identify a setting for a sensory factor (step 66). The identified setting satisfies a rule applied to the preference data. The rule includes averaging such that the setting represents, at least in part, an average of the preferred setting values of the of the individuals identified in step 62. Referring again to FIGS. 2 and 3, preference engine 32 may implement step 62 by accessing the preference data from table 38 for the individuals identified in step 62.

The setting identified in step 66 is, before the individuals are schedule to be present in the environment, applied to modify the sensory factor from a current state to a desired state (step 68). Referring to FIGS. 1 and 2, update engine 64 may implement step 68 by communicating the setting to control system 14.

As alluded earlier, the group of individuals identified in step 62 may not be the group of individuals who are present at the specified future time. In other words, not all of the identified individuals may be present as expected while additional unexpected individual may be present. Here, after the individuals identified in step 62 are expected to be present, a second group of individuals indicated as being actually present in the environment are identified. This second group differs from the group identified in step 62 in that includes at least one fewer or one additional individual. Preference data for that second group is then processed to identify an updated setting. The updated setting satisfies the rule applied to the preference data for the group of individual identified as actually present. The second setting is applied to modify the sensory factor from the desired state of step 68 to an updated state reflective of the preference data of the second group.

The preference data for each of the plurality of individuals can include a priority indicator. Step 66 can then include processing the preference data for the plurality of individuals to identify a setting that satisfies the rule such that the rule prioritizes the preferred setting values of the plurality of individuals according to the priority indicators. Thus, the setting identified in step 66 is influenced more by the preferred setting value of a first of the plurality of individual whose priority indicator is ranked higher than that of a second of the plurality of individuals.

The priority indicator for a first of the plurality of individuals is indicative of a physical limitation with respect to the sensory factor. Step 66 can include processing the preference data for the plurality of individuals to identify a setting that satisfies the rule such that the rule prioritizes the preferred setting value of the first individual. In other words, the identified in step 66 substantially matches the preferred setting value of the first of the plurality of individuals.

CONCLUSION: FIGS. 1-4 aid in depicting the architecture, functionality, and operation of various embodiments. In particular, FIGS. 1-4 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any memory resource for use by or in connection with processing resource. A “processing resource” is an instruction execution system such as a computer/processor based system or an ASIC (Application Specific Integrated Circuit) or other system that can fetch or obtain instructions and data from computer-readable media and execute the instructions contained therein. A “memory resource” is any non-transitory storage media that can contain, store, or maintain programs and data for use by or in connection with the instruction execution system. The term “non-transitory is used only to clarify that the term media, as used herein, does not encompass a signal. Thus, the memory resource can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagram of FIG. 5 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A memory resource storing instructions that when executed cause a processing resource to implement a system for managing a sensory factor for an environment, the instructions comprising:
a presence module to process, at a first time, presence data to identify a plurality of individuals scheduled to be present in the environment at a second, later time;
a preference module to process, before the individuals are scheduled to be present in the environment, preference data for the plurality of individuals to identify a setting for the sensory factor that satisfies a rule applied to the preference data, the setting corresponding to a desired state for the sensory factor; and
an update module to apply the setting to modify the sensory factor from a current state to the desired state before the individuals are schedule to be present.

2. The memory resource of claim 1, wherein;
The presence data is first presence data, the first plurality of individuals is a first plurality of individuals, the setting is a first setting, and the desired state is a first desired state;
the presence module is configured to, after the individuals are expected to be present, process second presence data to identify a second plurality of individuals identified as being present in the environment;
the preference module is configured to process preference data for the second plurality of individuals to identify a second setting for the sensory factor that satisfies the rule applied to the preference data for the second plurality of individuals, the second setting corresponding to a second desired state for the sensory factor; and
the update module is configured to apply the second setting to modify the sensory factor from the first desired state to the second desired state.

3. The memory resource of claim 2, wherein the first presence data is calendar data indicative of expected locations and the second presence data is location data indicative of current locations.

4. The memory resource of claim 1, wherein:
the preference data for each of the plurality of individuals includes a preferred setting value indicative of that individual's preference; and
the preference module is configured to process the preference data for the plurality of individuals to identify a setting that satisfies the rule, wherein in the rule includes averaging such that the identified setting represents an average of two or more of the plurality of preferred setting values.

5. The memory resource of claim 1, wherein;
the preference data for each of the plurality of individuals includes a priority indicator and preferred setting value indicative of that individual's preference;
the preference module is configured to process the preference data for the plurality of individuals to identify a setting that satisfies the rule, wherein in the rule prioritizes the preferred setting values of the plurality of individuals according to the priority indicators such that the identified setting is influenced more by the preferred setting value of a first of the plurality of individual's whose priority indicator is ranked higher than that of a second of the plurality of individuals.

6. The memory resource of claim 4, wherein;
the priority indicator for a first of the plurality of individuals is indicative of a physical limitation with respect to the sensory factor;
the preference module is configured to process the preference data for the plurality of individuals to identify a setting that satisfies the rule, wherein in the rule prioritizes the preferred setting value of the first individual such that the identified setting substantially matches the preferred setting value of the first of the plurality of individuals.

7. A system for managing a sensory factor for an environment comprising:
a preference engine to process, at a first time, preference data for a plurality of individuals expected be present in the environment, preference data for the plurality of individuals to identify a setting for the sensory factor that satisfies a rule applied to the preference data, the setting corresponding to a desired state for the sensory factor at a second time when the plurality of individuals are expended to be present in the environment; and
an update engine to apply the setting to modify the sensory factor from a current state to the desired state before the plurality of individuals are schedule to be present.

8. The system of claim 7, wherein:
the plurality of individuals are a first plurality of individuals, the setting is a first setting, and the desired state is a first desired state;
the system comprises a presence engine configured to process presence data after the first plurality of individuals are schedule to be present, to identify a second plurality of individuals present in the environment as indicated by the presence data;
the preference engine is configured to process preference data for the second plurality of individuals to identify a second setting for the sensory factor that satisfies the rule applied to the preference data for the second plurality of individuals, the second setting corresponding to a second desired state for the sensory factor; and
the update engine is configured to apply the second setting to modify the sensory factor from the first desired state to the second desired state.

9. The memory resource of claim 7, wherein:
the preference data for each of the plurality of individuals includes a priority indicator and preferred setting value indicative of that individual's preference; and
the preference engine is configured to process the preference data for the plurality of individuals to identify a setting that satisfies the rule, wherein in the rule includes weighted averaging such that the identified setting represents an average of the preferred setting values weighted according to the corresponding priory indicators.

10. The system of claim 7 wherein;
the preference data for each of the plurality of individuals includes a priority indicator corresponding to the individual's status and a preferred setting value indicative of that individual's setting preference for the sensory factor;
the preference engine is configured to process the preference data for the plurality of individuals to identify a setting that satisfies the rule, wherein in the rule prioritizes the preferred setting values of the plurality of individuals according to the priority indicators such that the identified setting is influenced more by the preferred setting value of a first of the plurality of individuals whose priority indicator indicates a first status that is ranked above a second status of a second of the plurality of individuals.

11. A method for managing a sensory factor for an environment comprising:
identifying a plurality of individuals expected to be present in an environment at a future time;
accessing preference data for the plurality of individuals, the preference data for each individual including a preferred setting value;
processing preference data for the identified plurality of individuals to identify a setting for the sensory factor, the setting satisfying a rule applied to the preference data, the rule includes averaging such that the setting represents, at least in part, an average of the preferred setting values of the plurality of individuals; and
applying the setting to modify the sensory factor from a current state to a desired state before the individuals are schedule to be present.

12. The method of claim 11, wherein the plurality of individuals is a first plurality of individuals, the setting is a first setting, and the desired state is a first desired state;
the method includes identifying a second plurality of individuals indicated as being present in the environment after the first plurality of individuals are expected to be present, the second plurality differing from the first plurality;
processing preference data for the second plurality of individuals to identify a second setting for the sensory factor, the second setting satisfying the rule applied to the preference data for the second plurality of individuals, the second setting corresponding to a second desired state for the sensory factor; and
applying the second setting to modify the sensory factor from the first desired state to the second desired state.

13. The method of claim 1, wherein:
the preference data for each of the plurality of individuals includes a priority indicator;
processing comprises processing the preference data for the plurality of individuals to identify a setting that satisfies the rule, wherein in the rule prioritizes the preferred setting values of the plurality of individuals according to the priority indicators such that the identified setting is influenced more by the preferred setting value of a first of the plurality of individual's whose priority indicator is ranked higher than that of a second of the plurality of individuals.

14. The method of claim 13, wherein;
the priority indicator for a first of the plurality of individuals is indicative of a physical limitation with respect to the sensory factor; and
processing comprises processing the preference data for the plurality of individuals to identify a setting that satisfies the rule, wherein in the rule prioritizes the preferred setting value of the first individual such that the identified setting substantially matches the preferred setting value of the first of the plurality of individuals.

15. The method of claim 13, wherein;
the priority indicator for each of the plurality of individuals corresponds to that individual's status; and
processing comprises processing the preference data for the plurality of individuals to identify a setting that satisfies the rule, wherein in the rule prioritizes the preferred setting values of the plurality of individuals according to the priority indicators such that the identified setting is influenced more by the preferred setting value of a first of the plurality of individuals whose priority indicator indicates a first status that is ranked above a second status of a second of the plurality of individuals.
